(19) United States
(12) Patent Application Publication
(10) Pub. No.: US 2013/0112551 A1
(43) Pub. Date: May 9, 2013

(54) COVER FOR AN ELECTRO-CHEMICAL DEVICE AND A METHOD FOR CONTACTING ELECTRO-CHEMICAL CELLS OF AN ELECTRO-CHEMICAL DEVICE

(71) Applicant: ElringKlinger AG, Dettingen (DE)

(72) Inventor: Wolfgang Fritz, Metzingen (DE)

(73) Assignee: ElringKlinger AG, Dettingen (DE)

(21) Appl. No.: 13/670,181

(22) Filed: Nov. 6, 2012

(30) Foreign Application Priority Data
Nov. 8, 2011 (DE) 10 2011 085 930.6

(51) Int. Cl. C25C 7/00; H01R 43/20

(52) U.S. Cl. CPC C25C 7/00; H01R 43/20
USPC 204/267; 204/279; 29/825

(57) ABSTRACT

A cell contacting system for an electro-chemical device which provides increased protection from damage and enables simple assembly of the electro-chemical device comprises a cover for an electro-chemical device which comprises a plurality of electro-chemical cells, wherein the cover comprises the following:
a carrier element having at least one access opening which is associated with a functional element of the electro-chemical device; and
at least one closure element which is held on the carrier element in such a way that the closure element is movable relative to the carrier element from a closed position, in which the closure element closes at least one access opening of the carrier element, into an open position in which the closure element exposes the at least one access opening of the carrier element so that the functional element associated with the access opening concerned is accessible from outside the electro-chemical device.

### CROSS-REFERENCE TO RELATED APPLICATION

The present disclosure relates to the subject matter disclosed in German Patent Application No. 10 2011 085 930.6, filed Nov. 8, 2011, the entire specification of which is incorporated herein by reference.

### FIELD OF THE INVENTION

The present invention relates to a cover for an electro-chemical device which comprises a plurality of electro-chemical cells.

### BACKGROUND OF THE INVENTION

Currently known cell contacting systems for electro-chemical devices consist of a mounting plate for holding functional elements of the electro-chemical device such as cell connectors in particular, a cover and the aforementioned functional elements of the electro-chemical device, whereby additional printed circuit boards, plugs and wiring harnesses may be included for the purposes of monitoring the electro-chemical cells. The mounting plate is used in order to fix and position the other components of the cell contacting system in the correct position. Thereafter, the assembly consisting of the mounting plate and the functional elements is mounted on a prefabricated electro-chemical module of the electro-chemical device, and then contact is made between the electro-chemical cells and the functional elements, and in particular, the cell connectors. The electrical interconnection of the individual electro-chemical cells is thereby effected. After contact has been made, the cover, which serves as a means for preventing the components that are live in the operative state of the electro-chemical device from being touched, is mounted on the electro-chemical module.

### SUMMARY OF THE INVENTION

The object of the present invention is to produce a cell contacting system for an electro-chemical device which provides enhanced protection from damage and enables the electro-chemical device to be assembled in a simple manner

In accordance with the invention, this object is achieved by a cover for an electro-chemical device which comprises a plurality of electro-chemical cells wherein the cover comprises the following:
a carrier element having at least one access opening which is associated with a functional element of the electro-chemical device; and
at least one closure element which is held on the carrier element in such a manner that the closure element is movable relative to the carrier element from a closed position, in which the closure element closes at least one access opening of the carrier element, into an open position, in which the closure element exposes the at least one access opening of the carrier element, so that the functional element associated with the access opening concerned is accessible from outside the electro-chemical device.

In particular, in the open position of the closure element, the functional element that is associated with an access opening is accessible through the cover in accordance with the invention for assembly, maintenance or repair purposes.

When assembling the electro-chemical device, the functional element such as a cell connector for example can, in particular, be connected to a cell terminal of an electro-chemical cell of the electro-chemical device through the access opening in the carrier element, the contact preferably being made by means of a material-uniting bond.

Due to the cover in accordance with the invention, it is possible to completely pre-assemble a cell contacting system for an electro-chemical device before arranging it on an electro-chemical module of the electro-chemical device or on a housing of such an electro-chemical module and to transport and process the pre-assembled cell contacting system in the closed position of the closure element such that it is well-protected from damage.

During the process of assembling the electro-chemical device and in particular when effecting the material-uniting bonding of the functional elements to the cell terminals of the electro-chemical cells, and also in the operative state of the electro-chemical device, the danger of inadvertently touching electrically conductive parts of the electro-chemical device from outside the electro-chemical device is considerably reduced.

In connection therewith, the electro-chemical device may comprise one or more electro-chemical modules.

It is to be understood in this description and in the accompanying Claims that a “cover” for an electro-chemical device is any element which is intended for covering at least a part of the electro-chemical device. The covered part may, in particular, be an electro-chemical module of the electro-chemical device or else just a part of an electro-chemical module.

In a preferred embodiment of the invention, the closure element has at least one through opening which at least partially overlaps an access opening of the carrier element in the open position of the closure element. This thereby enables easy access to be made to the functional element associated with the access opening concerned through the through opening and the access opening in the open position of the closure element.

Preferably, the through opening of the closure element overlaps the access opening of the respectively associated carrier element substantially completely in the open position of the closure element.

It is particularly expedient if a cross-sectional area of the through opening in the closure element is larger than a cross-sectional area of the access opening in the carrier element.

In order to enable the cover to be handled as a unit in a simple manner, it is of advantage if the closure element is held captive on the carrier element.

In particular, provision may be made for the closure element to be formed in one piece manner with the carrier element.

Various types of movement come into consideration for providing ways in which the closure element moves relative to the carrier element from the closed position into the open position.

Thus in the case of one preferred embodiment of the invention, provision is made for the closure element to be displaceable relative to the carrier element from the closed position into the open position (and/or from the open position into the closed position).

As an alternative or in addition thereto, provision may also be made for the closure element to be pivotal, foldable or rotatable relative to the carrier element from the closed position into the open position (or from the open position into the closed position).

Thus in particular the closure element may be a slider or a flap.

Furthermore, provision may be made for the closure element to be connected by a film hinge to the carrier element, and in particular, to be moulded onto the carrier element.

If the closure element is displaceable relative to the carrier element, then the cover preferably comprises a guidance device by means of which the closure element is guided in displaceable manner relative to the carrier element.

Furthermore, provision may be made for the closure element to be formed as a separate part from the carrier element and to be removable from the carrier element.

In this case, the closure element is arranged on the carrier element in the closed position and is removed from and in particular lifted off the carrier element in the open position.

There is no need for there to be any type of connection between the closure element and the carrier element in the open position of the closure element.

A particularly well defined closed position and/or open position of the closure element relative to the carrier element is obtained if the closure element is latchable to the carrier element by means of a latching device in the closed position and/or in the open position.

In order to enable especially voltage tapping lines and temperature measuring lines, which lead to the functional elements of the electro-chemical device, to be mounted on the cover in a particularly simple way, it is of advantage if at least one conduit system is arranged on the carrier element, wherein the conduit system comprises at least one line which is attached to a cell connector for interconnecting a first cell terminal of a first electro-chemical cell and a second cell terminal of a second electro-chemical cell of the electro-chemical device in an electrically conductive manner

Such a conduit system may, in particular, comprise a reinforcement structure on which the electrical lines leading to the functional elements are held in preferably releasable manner.

In turn, the reinforcement structure itself can be fixed to the carrier element or else formed in one piece manner with the carrier element.

In order to achieve the effect that the cover provides particularly effective protection from inadvertent contact with live components of the electro-chemical device, it is expedient if the entire cross-sectional area of the access openings in the carrier element amounts to less than half, and preferably less than a quarter of the surface area covered by the outer contour of the carrier element.

In principle, the closure element can be arranged on the outer surface of the carrier element which is remote from the electro-chemical cells of the electro-chemical device or on the inner surface of the carrier element which faces the electro-chemical cells of the electro-chemical device.

In the case of one preferred embodiment of the invention, provision is made for the closure element to be arranged on the outer surface of the carrier element which is remote from the electro-chemical cells of the electro-chemical device because a closure element arranged on this side of the carrier element is particularly easily accessible for effecting the relative movement of the closure element relative to the carrier element from the open position into the closed position or from the closed position into the open position of the closure element.

Particularly simple assembly of the electro-chemical device is obtained, if at least one functional element of the electro-chemical device, in particular, at least one cell connector and/or at least one electrical power terminal of the electro-chemical device, is mounted on the carrier element. The number of assemblies that need to be handled when assembling the electro-chemical device is thereby reduced.

The functional element is preferably an electrically conductive functional element of the electro-chemical device.

Provision may be made, in particular, for at least one cell connector for the electrically conductive interconnection of a first cell terminal of a first electro-chemical cell and a second cell terminal of a second electro-chemical cell of the electro-chemical device to be mounted on the carrier element.

Simple contact with the cell terminals by such a cell connector when assembling the electro-chemical device is obtained, if a contact region of the at least one cell connector, at which the cell connector is connectable to the first cell terminal or to the second cell terminal, is accessible through an access opening of the carrier element in the open position of the closure element.

Preferably, the contact region of the cell connector is no longer accessible from the exterior of the electro-chemical device in the closed position of the closure element so that inadvertent touching of the cell connector is impossible in the closed position of the closure element.

The carrier element and/or the closure element of the cover in accordance with the invention are preferably formed from an electrically non-conductive material, in particular, from a synthetic material.

In particular, the synthetic material can comprise PBT (polybutylene terephthalate), PP (polypropylene), PA (polyamide), ABS (acrylonitrile butadiene styrene), and/or LCP (“Liquid Crystal Polymer”).

Particularly suitable as the material for the carrier element and/or for the closure element is a polypropylene material reinforced with talcum (for example, the material bearing the designation PP TV20).

The cover in accordance with the invention is suitable, in particular, for use in an electro-chemical device which comprises a plurality of electro-chemical cells and a cover in accordance with the invention.

In particular, such an electro-chemical device can be in the form of an accumulator such as a lithium ion accumulator for example.

If the electro-chemical device in accordance with the invention is in the form of an accumulator, it is particularly suitable as a heavy-duty energy source for powering motor vehicles for example.

Furthermore, the present invention relates to a method for contacting electro-chemical cells of an electro-chemical device.

The object of the present invention is to provide such a method by means of which the danger of damage to components of the electro-chemical device during and/or after the assembly of the electro-chemical device is reduced and the assembly of the electro-chemical device is simplified.

In accordance with the invention, this object is achieved by a method for contacting electro-chemical cells of an electro-chemical device which comprises the following process steps:
mounting at least one cell connector for the electrically conductive connection of a first cell terminal of a first electro-chemical cell and a second cell terminal of a second electro-chemical cell on a carrier element of a cover;
arranging the cover on the electro-chemical device;
connecting a first contact region of the at least one cell connector to the first cell terminal of the first electro-chemical cell and a second contact region of the cell connector to the second cell terminal of the second electro-chemical cell whilst a closure element of the cover is in an open position in which the closure element exposes at least one access opening of the carrier element so that the contact regions of the cell connector are accessible from outside the electro-chemical device;
moving the closure element from the open position into a closed position in which the closure element closes the at least one access opening of the carrier element.

Furthermore, the method in accordance with the invention can comprise the process step of pre-assembling the closure element on the carrier element.

Furthermore, the method in accordance with the invention can comprise the process step of pre-assembling a conduit system. The conduit system may comprise, in particular, at least one line which is attached to at least one cell connector for the electrically conductive connection of a first cell terminal of a first electro-chemical cell and a second cell terminal of a second electro-chemical cell of the electro-chemical device

The conduit system may comprise, in particular, a wiring harness and/or a printed circuit board.

Furthermore, the conduit system can be attached to a printed circuit board and/or to a monitoring device of the electro-chemical device.

Such a monitoring device may serve, in particular, for detecting the electrical potentials on one or more of the cell terminals of the electro-chemical device and/or for monitoring the temperature of at least one cell terminal of the electro-chemical device.

The cover in accordance with the invention can be moved from the closed position into the open position, in particular, by a pushing or a folding movement or by removal of the carrier element and, in the open position thereof, it preferably exposes only the regions of the functional elements of the electro-chemical device which are to be contacted.

Thereby, damage to the cell contacting system formed by the cover is prevented when transporting and assembling the electro-chemical device.

The relatively small access openings in the carrier element in the vicinity of the contact points of the electro-chemical cells significantly reduce the risk of touching the electrically conductive parts of the electro-chemical device and thus substantially decrease the potential danger.

The cover is provided with mounting openings.

The cover can, in particular, be in the form of a sliding or folding cover.

Due to the use of the cover in accordance with invention, the number of components needed for the construction of the electro-chemical device is reduced whereby the logistical expenditure needed for the assembly of the electro-chemical device is reduced.

In particular, additional components can be avoided if the functional elements and especially the cell connectors are arranged on the inner side of the carrier element facing the electro-chemical cells and if these functional elements are accessible through access openings in the mounting plate from an outer side of the carrier element remote from the electro-chemical cells when the closure element is in the open position.

The carrier element is preferably provided with access openings at the positions at which contact with the electro-chemical cells (by means of a cell connector or an electrical power terminal) is to take place.

A pre-assembled closure element in the form of a sliding cover for example closes these access openings after contact has been made.

Upon delivery, the closure element can be in the open position or in the closed position.

The open position and/or the closed position of the closure element relative to the carrier element is defined by a stop and/or by a latching means.

A reinforcement structure of at least one conduit system can be pre-mounted on the carrier element by means of a latching arrangement or a clip or by means of a material-uniting bond, in particular by welding for example.

The at least one conduit system is preferably arranged between the carrier element and the electro-chemical cells in the assembled state of the electro-chemical device.

The carrier element is preferably in the form of a mounting plate and the closure element is preferably in the form of a closure plate.

Further features and advantages of the invention form the subject matter of the following description and the graphic illustration of an exemplary embodiment.

### BRIEF DESCRIPTION OF THE DRAWINGS

FIG. 1 shows a schematic perspective illustration of an accumulator module having a housing in which a plurality of electro-chemical cells are arranged and which is closed by a cover which comprises a carrier element and a closure element that is held on the carrier element in displaceable manner;

FIG. 2 shows a schematic perspective illustration of the accumulator module depicted in FIG. 1, wherein the cover has been lifted upwardly from the housing of the accumulator module;

FIG. 3 shows a schematic perspective illustration of the cover of the accumulator module depicted in FIGS. 1 and 2, wherein the closure element is in a closed position in which the closure element closes access openings of the carrier element;

FIG. 4 shows a schematic perspective illustration of the cover depicted in FIG. 3, wherein the closure element has been moved relative to the carrier element from the closed position into an open position in which the closure element exposes a plurality of access openings of the carrier element so that functional elements associated with the access openings concerned are accessible through the access openings of the carrier element;

FIG. 5 shows a schematic perspective exploded illustration of the cover depicted in FIGS. 3 and 4 from which it can be seen that the cover comprises a closure element, a carrier element and functional elements such as cell connectors in particular which are arranged on the side of the carrier element remote from the closure element, and also conduit systems for connecting voltage tapping points and temperature measuring points of the functional elements to multipolar connector plugs;

FIG. 6 shows a schematic perspective illustration of the cover depicted in FIGS. 2 to 5 as viewed from the side of the carrier element remote from the closure element showing the functional elements especially in the form of cell connectors which are arranged there and also the conduit systems that are arranged there;

FIG. 7 shows a schematic perspective illustration of an accumulator module with a housing in which are arranged a plurality of electro-chemical cells and which is closed by a second embodiment of a cover that comprises a carrier element and two closure elements which are hinged or held pivotally on the carrier element;

FIG. 8 shows a schematic perspective illustration of the accumulator module depicted in FIG. 7, wherein the cover has been lifted upwardly from the housing of the accumulator module;

FIG. 9 shows a schematic perspective illustration of the cover of the accumulator module depicted in FIGS. 7 and 8, wherein the closure elements are in a closed position in which the closure elements close the access openings of the carrier element;

FIG. 10 shows a schematic perspective illustration of the cover depicted in FIG. 9, wherein the closure elements have been folded relative to the carrier element from the closed position into an open position in which the closure elements expose a plurality of access openings of the carrier element so that functional elements associated with the access openings concerned are accessible through the access openings of the carrier element;

FIG. 11 shows a schematic perspective exploded illustration of the cover depicted in FIGS. 9 and 10, from which it can be seen that the cover comprises a carrier element, two closure elements that are connected to the carrier element in hinged manner and functional elements such as especially cell connectors and conduit systems for connecting voltage tapping points and temperature measuring points of the functional elements to multipolar connector plugs which are arranged on the side of the carrier element remote from the closure elements in the closed position thereof;

FIG. 12 shows a schematic perspective illustration of the cover depicted in FIGS. 8 to 11 as viewed from the side of the carrier element remote from the closure elements in the closed position thereof and also the functional elements such as cell connectors in particular which are arranged there, and also the conduit systems that are arranged there; and

FIG. 13 shows a schematic perspective exploded illustration of a third embodiment of a cover for an accumulator module from which it can be seen that the cover comprises a carrier element, a closure element which is formed separately from the carrier element and is removed from the carrier element in an open position of the closure element and is latchable to the carrier element in a closed position of the closure element and also functional elements such as especially cell connectors and conduit systems for connecting voltage tapping points and temperature measuring points of the functional elements to multipolar connector plugs which are arranged on the side of the carrier element remote from the closure element.

Similar or functionally equivalent elements are designated by the same reference symbols in all of the Figures.

### DETAILED DESCRIPTION OF THE INVENTION

An electro-chemical device bearing the general reference 100 comprises a plurality of electro-chemical modules 102 for example, each of which comprises a plurality, twelve in the illustrated exemplary embodiment, of electro-chemical cells 104 which are arranged next to each other in a housing 106 of the electro-chemical module 102.

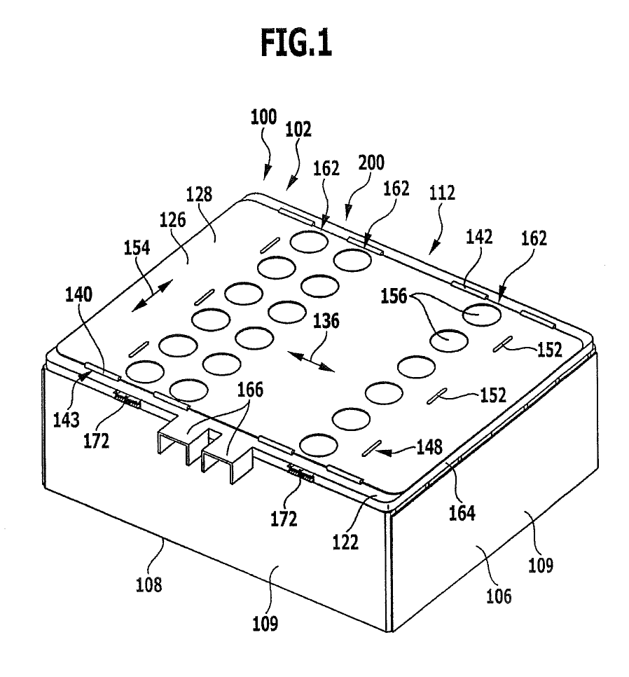

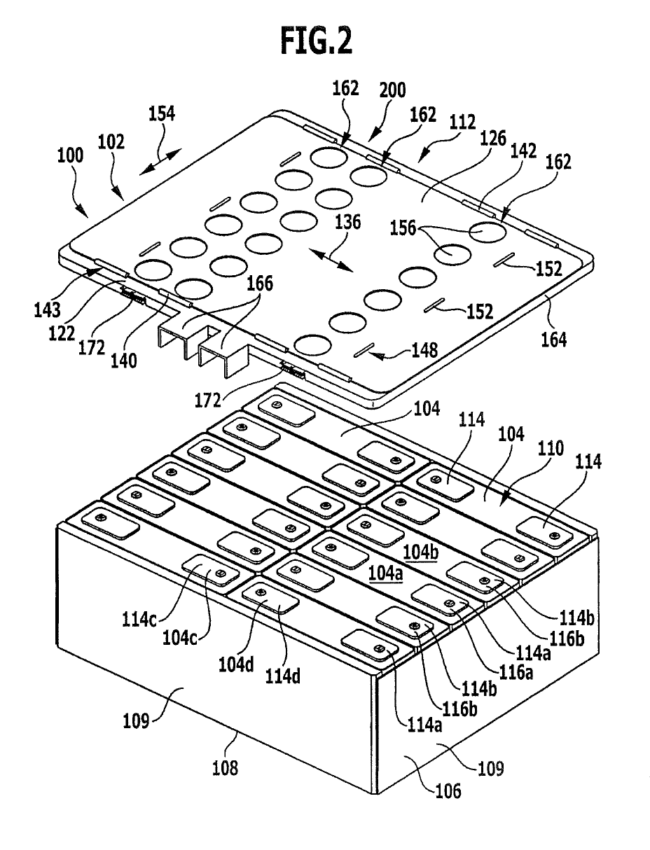

The housing 106 can, for example, be substantially cuboidal having a bottom wall 108 and side walls 109 extending away from the bottom wall, the edges of said side walls remote from the bottom wall 108 surrounding a housing opening 110 which is closable by means of a cover 112 (see FIGS. 1 and 2).

The electro-chemical cells 104 are arranged and oriented in the housing 106 of the electro-chemical module 102 in such a way that the two cell terminals 114 of each electro-chemical cell 104 are arranged on the side of the respective electro-chemical cell 104 facing the cover 112.

In each of the electro-chemical cells 104, one of the cell terminals 114 forms a negative pole 116a and the respective other cell terminal 114 forms a positive pole 116b of the electro-chemical cell 104 concerned.

The electro-chemical device 100 can, in particular, be in the form of an accumulator and in particular a lithium ion accumulator of the type LiFeP0₄ for example.

Accordingly, the electro-chemical modules 102 can be in the form of accumulator modules and the electro-chemical cells 104 in the form of accumulator cells and in particular lithium-ion accumulator cells of the type LiFeP0₄ for example.

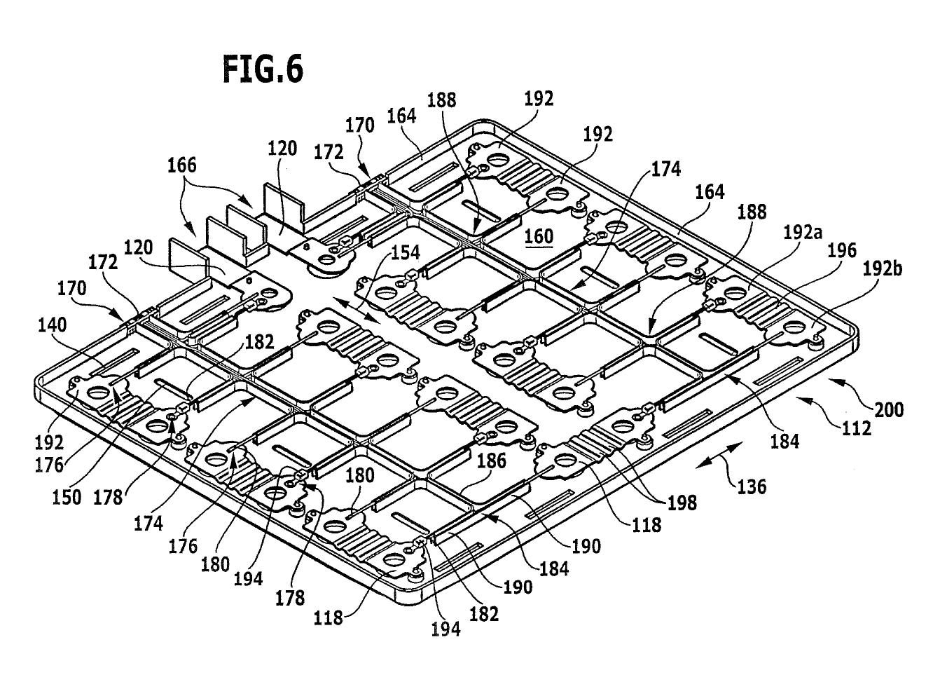

Furthermore, the electro-chemical module 102 comprises a plurality of cell connectors 118 (see in particular FIG. 6), by means of which the cell terminals 114 of mutually adjacent electro-chemical cells 104 of differing polarity are connectable to each other in electrically conductive manner in order to connect all the electro-chemical cells 104 of an electro-chemical module 102 electrically in series in this way.

In connection therewith, each cell connector 118 connects a first cell terminal 114c of negative polarity of a first electro-chemical cell 104a to a second cell terminal 114d of positive polarity of a neighbouring second electro-chemical cell 104b (see FIG. 2).

In each case, a cell terminal 114c of the electro-chemical cell 104c forming the beginning of the series connection of cells of the electro-chemical module 102 and a cell terminal 114d of the electro-chemical cell 104d forming the end of the series connection of cells are connected in electrically conductive manner to an electrically conductive power terminal 120 of the electro-chemical module 102 (see FIGS. 2 and 6).

The plurality of electro-chemical modules 102 of the electro-chemical device 100 are preferably connected electrically in series.

Hereby in particular, such a series connection can be produced by connecting an electrical power terminal 120 of a first electro-chemical module to an electrical power terminal 120 (of opposite polarity) of a second electro-chemical module in electrically conductive manner by means of a (not shown) module connector.

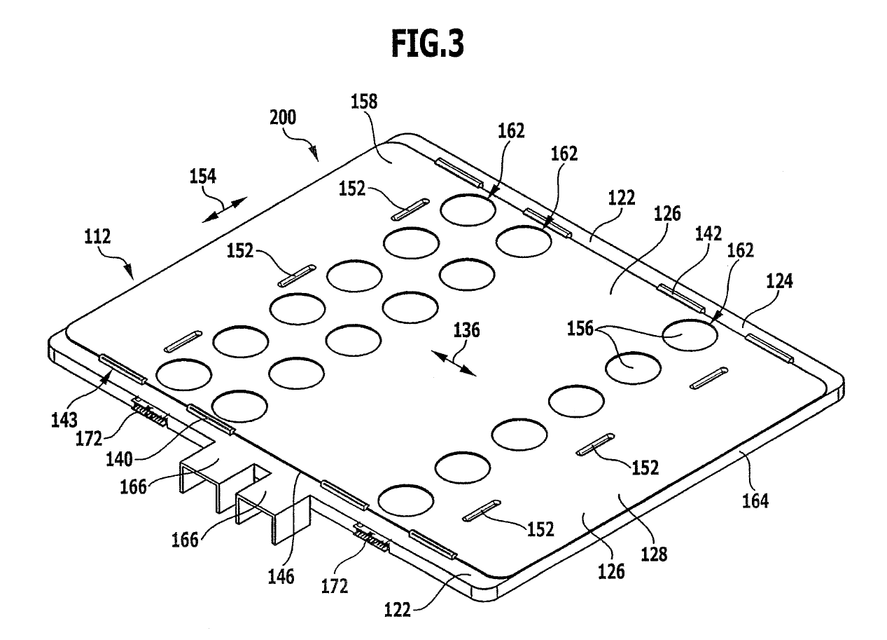

The cover 112 which is placeable on the housing 106 and which closes the housing opening 110 when in the mounted state is illustrated in detail in FIGS. 3 to 6.

The cover 112 comprises a carrier element 122 in the form of a preferably substantially rectangular mounting plate 124 for example, and a closure element 126 which is held on the carrier element 122 in displaceable manner and is in the form of a preferably substantially rectangular closure plate 128 for example.

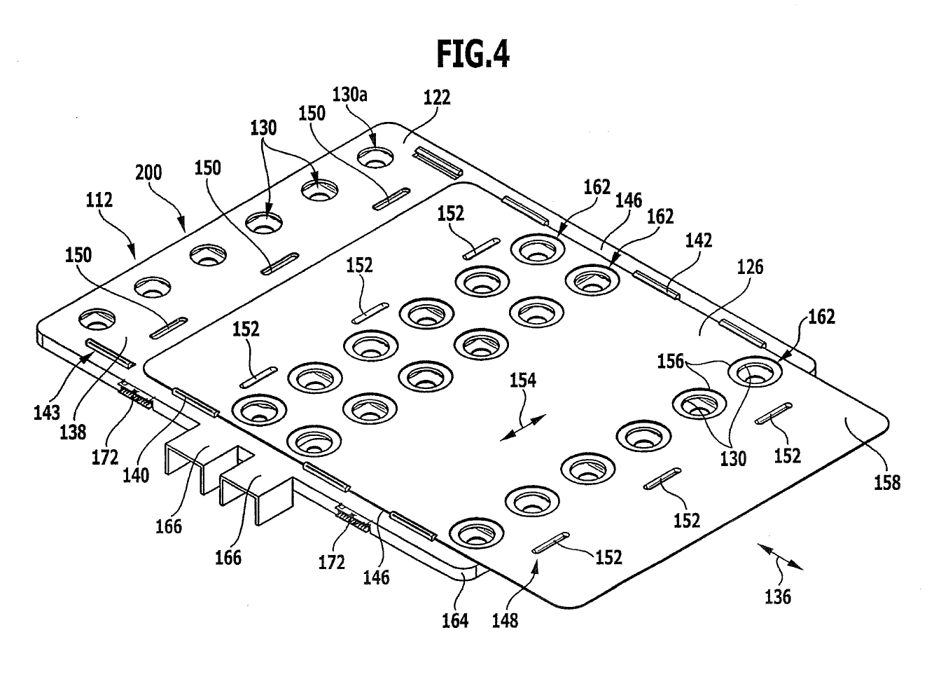

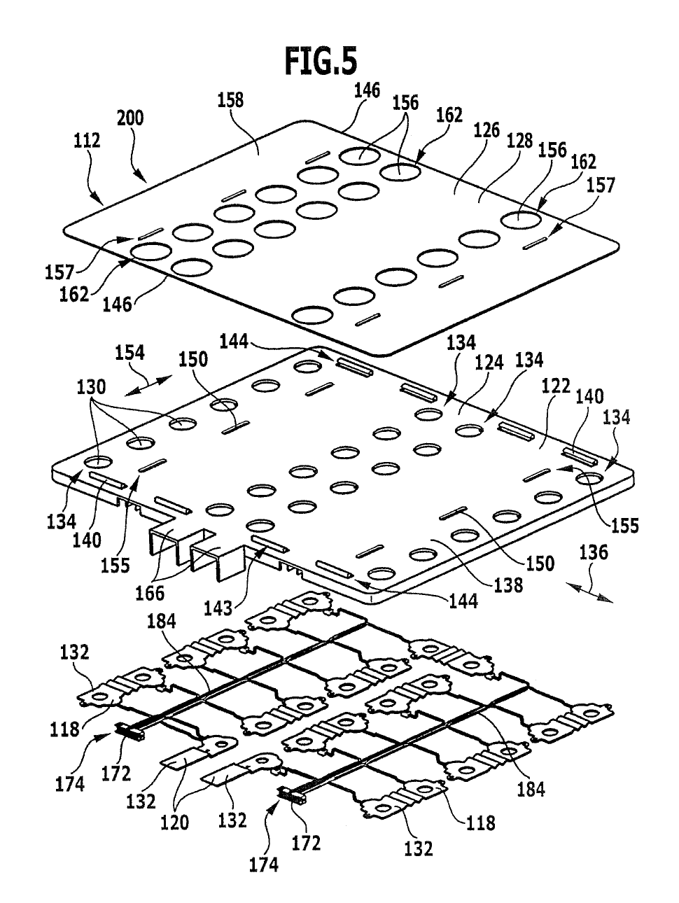

As can best be seen from FIG. 5, the carrier element 122 is provided with a plurality of access openings 130, wherein each access opening 130 is associated with a respective functional element 132 of the electro-chemical device 100 and in particular, of the electro-chemical module 102, and the respectively associated functional element 132 is accessible through the access opening 130 from outside the electro-chemical device 100 especially for assembly, maintenance or repair purposes when the closure element 126 of the cover 112 is in the open position illustrated in FIG. 4 in which the closure element 126 exposes the point of access to the access openings 130 of the carrier element 122.

As can best be seen from FIG. 5, the access openings 130 of the carrier element 122 can be arranged in a plurality of rows 134, wherein the rows 134 preferably extend transversely, and in particular substantially perpendicularly, to a direction of displacement 136 along which the closure element 126 is displaceable relative to the carrier element 122.

In particular, the access openings 130 can be substantially circular; basically however, other shapes of access openings and in particular, oval, rectangular, square or polygonal access openings 130 are possible.

Furthermore, on the outer surface 138 of the carrier element 122 facing the closure element 126 in the mounted state of the cover 112, the carrier element 122 is provided with a plurality of guide elements 140 which serve for the guidance of a displacement movement of the closure element 126 relative to the carrier element 122.

The guide elements 140 can, for example, be in the form of guide strips 142 which grip the closure element 126 in the mounted state of the cover 112 (see in particular, FIGS. 3 and 4).

For example, the guide elements 140 can be arranged in two rows 144 which extend along the direction of displacement 136, whereby the guide elements 140 of each row 144 guide a respective lateral edge 146 of the closure element 126.

Thus, together, the guide elements 140 form a guidance device 143 by means of which the closure element 126 is guided during its movement from the open position into the closed position (or vice versa).

The displacement path of the closure element 126 relative to the carrier element 122 can be limited at one end or at both ends by a respective (not shown) stop so that the closure element 126 is preferably held captive on the carrier element 122.

In order to restrain the closure element 126 relative to the carrier element 122 in the closed position of the closure element 126 which is illustrated in FIG. 1, the cover 112 is provided with a latching device 148 which comprises one or more latching elements 150 on the carrier element side and one or more latching elements 152 on the closure element side. Preferably, each latching element 150 on the carrier element side cooperates with a respectively associated latching element 152 on the closure element side in order to latch the closure element 126 to the carrier element 122 in the closed position.

For example, the latching elements 152 on the closure element side may be in the form of projections directed towards the carrier element 122 and the latching elements 150 on the carrier element side can be in the form of recesses in which the latching elements 152 on the closure element side engage in the latched position of the closure element 126.

Conversely, the latching elements 150 on the carrier element side could also be in the form of projections directed towards the closure element 126 and the latching elements 152 on the closure element side be in the form of recesses.

Furthermore, it is also conceivable for both the latching elements 150 on the carrier element side and the latching elements 152 on the closure element side to be in the form of projections directed towards the other respective element, said latching elements being resiliently deformable so that the latching elements 152 on the closure element side are movable past the latching elements 150 on the carrier element side into their latching position due to the resilient deformation of the latching elements 152 on the closure element side and/or of the latching elements 150 on the carrier element side.

The latching elements 150 of the latching device 148 on the carrier element side are preferably arranged in one or more, two for example, rows 155 which extend in parallel with a transverse direction 154 of the cover 112 that runs perpendicularly to the direction of displacement 136, and the latching elements 152 on the closure element side are preferably arranged in rows 157 which likewise extend in parallel with the transverse direction 154 of the cover 112 in a number of rows that corresponds to the number of rows of latching elements 150 on the carrier element side.

Furthermore, the closure element 126 has one or more through openings 156 which at least partly, but preferably substantially completely, overlap a respectively associated access opening 130 of the carrier element 122 in the open position of the closure element 126 so that access from the outer surface 158 of the closure element 126 remote from the carrier element 122 through the through opening 156 and the access opening 130 to the inner surface 160 of the carrier element 122 remote from the closure element 126 is possible in the open position of the closure element 126 (see FIG. 6).

The through openings 156 in the closure element 126 preferably have larger cross-sectional areas than the access openings 130 in the carrier element 122.

The through openings 156 of the closure element 126 can be arranged in one or more rows 162 which preferably extend in parallel with the transverse direction 154 of the cover 112 (see FIG. 5).

In the open position of the closure element 126 illustrated in FIG. 4, a row 162 of through openings 156 of the closure element 126 is preferably arranged above an associated row 134 of access openings 130 of the carrier element 122 so that the through openings 156 at least partly, but preferably substantially completely, overlap with the respectively associated access openings 130 of the carrier element 122.

Furthermore, provision may be made for one or more access openings 130 of the carrier element 122 to be exposed in the open position of the closure element 126 by moving the closure element 126 which covers these access openings 130 in the closed position of the closure element 126 illustrated in FIG. 1 away from these access openings 130a in the direction of displacement 136.

Consequently, none of the through openings 156 in the closure element 126 are associated with the access openings 130a of the carrier element 122 that have been exposed in this way in the open position of the closure element 126.

The number of through openings 156 in the closure element 126 can thus be smaller than the number of access openings 130 in the carrier element 122.

Furthermore, as can best be seen from FIG. 6, the carrier element 122 is preferably provided with a boundary region 164 that extends along its outer edge and projects towards the housing 106 in the mounted state of the cover 112.

The boundary region 164 may be interrupted by two through channels 166 which project outwardly from the edge of the carrier element 122, preferably in the transverse direction 154, and they may have a substantially U-shaped cross section for example.

These through channels 166 respectively serve for accommodating one of the power terminals 120 of the electro-chemical module 102.

In the assembled state of the electro-chemical module 102, each power terminal 120 is respectively connected to a cell terminal 114c of the first electro-chemical cell 104c of the series circuit in the electro-chemical module 102 or to a cell terminal 114d of the last electro-chemical cell 104d of the series circuit in the electro-chemical module 102.

Furthermore, the boundary region 164 of the carrier element 122 is preferably provided with one or more recesses 170 for respectively accommodating a, preferably multipolar, plug 172.

Each plug 172 serves for connecting a conduit system 174 arranged on the carrier element 122 to a (not shown) monitoring unit of the electro-chemical device 100 by means of a (not shown), preferably multipolar, feeder line.

Two such conduit systems 174 are present in the embodiment of an electro-chemical module 102 illustrated in the Figures.

Each of the conduit systems 174 serves for connecting a plurality of voltage tapping points 176 and a plurality of temperature measuring points 178 of the electro-chemical module 102 to the (not illustrated) monitoring unit of the electro-chemical device 100.

Each conduit system 174 comprises a plurality of voltage tapping lines 180 which each lead from a respective voltage tapping point 176 to the plug 172 of the conduit system 174, and a plurality of temperature measuring lines 182 which each lead from a respective temperature measuring point 178 to the plug 172 of the conduit system 174, and also a reinforcement structure 184 on which the voltage tapping lines 180 and the temperature measuring lines 182 are arranged at least in sections thereof.

The reinforcement structure 184 of each conduit system 174 is preferably built up in tree-like manner and comprises a main seating channel 186 which extends in the transverse direction 154 of the cover 112 for example, and a plurality of auxiliary seating channels 190 which branch-off from the main seating channel 186 at branching points 188.

In connection therewith, provision is made in particular for the main seating channel 186 to accommodate a plurality of voltage tapping lines 180 and temperature measuring lines 182 of the conduit system 174, whilst each of the auxiliary seating channels 190 preferably accommodates just one voltage tapping line 180 and/or just one temperature measuring line 182.

The main seating channel 186 and/or the auxiliary seating channels 190 preferably have a substantially U-shaped cross section which opens out towards the side of the reinforcement structure 184 remote from the carrier element 122 so that the voltage tapping lines 180 and the temperature measuring lines 182 can be inserted into the reinforcement structure 184 from this side.

The reinforcement structure 184 is preferably formed in one piece manner and may comprise, in particular, an injection mouldable material such as PBT (polybutylene terephthalate), PP (polypropylene), PA (polyamide), ABS (acrylonitrile butadiene styrene), and/or LCP (“Liquid Crystal Polymer”) for example.

As an alternative or in addition thereto, provision may also be made for the reinforcement structure 184 to comprise a metallic material such as aluminium for example, and in particular, to be in the form of a metallic worked part such as a stamped and bent component.

The reinforcement structure 184 may comprise one or more retaining arrangements by means of which the voltage tapping lines 180 and the temperature measuring lines 182 are fixed to the reinforcement structure 184, preferably in releasable manner.

Such retaining arrangements can, for example, be in the form of hooks, clamps, latching elements, clips or the like which are arranged on the reinforcement structure 184 and/or on the lines 180 or 182.

In turn, each reinforcement structure 184 of a conduit system 174 can be fixed as a whole to the inner surface 160 of the carrier element 122, in particular, in releasable manner

The fixing of the reinforcement structure 184 to the carrier element 122 can be effected by a latching arrangement, by welding and/or by adhesion for example.

As an alternative thereto, provision may also be made for the reinforcement structure 184 to be formed in one piece manner with the carrier element 122

The end of each voltage tapping line 180 is connected in electrically conductive manner to a respective contact region 192 of a cell connector 118 or a power terminal 120 of the electro-chemical module 102 in order to enable the electrical potential prevailing there to be tapped-off.

The end of each temperature measuring line 182 is attached to a temperature sensor 194 in the form of an NTC element (“Negative Temperature Coefficient”) for example. Each temperature sensor 194 is likewise in contact with a contact region 192 of a cell connector 118 or with a power terminal 120 of the electro-chemical module 102 in order to enable the temperature prevailing there to be measured.

Each of the contact regions 192 of the cell connectors 118 and each power terminal 120 is associated with a respective cell terminal 114 of the electro-chemical module 102 and is connected in electrically conductive manner, preferably by a material-uniting bond, to the respectively associated cell terminal 114 in the assembled state of the electro-chemical module 102.

Each cell connector 118 comprises two contact regions 192a and 192b for electrically contacting a cell terminal 114 and a compensation region 196 which connects the two contact regions 192a and 192b together. The compensation region 196 is preferably resiliently and/or plastically deformable in order to enable relative movement of the two contact regions 192a and 192b of the cell connector 118 relative to each other in the operative state of the electro-chemical device 100 and/or to allow for tolerances when assembling the electro-chemical device 100.

For this purpose, the compensation region 196 may comprise in particular one or more compensatory undulations 198 that run transversely relative to a connecting direction which interconnects a centre of the first contact region 192a and a centre of the second contact region 192b of the cell connector 118.

The cover 112 of the electro-chemical module 102, which comprises the carrier element 122 including the conduit systems 174 and the closure element 126, forms a cell contacting system 200 for contacting and monitoring the electro-chemical cells 104 of the electro-chemical module 102.

The carrier element 122 preferably comprises an electrically non-conductive synthetic material such as PBT, PP, PA, ABS and/or LCP for example, and is preferably formed substantially entirely of such a synthetic material.

The closure element 126 preferably comprises an electrically non-conductive synthetic material such as PBT, PP, PA, ABS and/or LCP for example, and is preferably formed substantially entirely of such a synthetic material.

A particularly suitable material for the carrier element 122 and the closure element 126 is a polypropylene material reinforced with talcum (such as the material bearing the designation PP TV20 for example). The inherent stability of this material is extremely high due to the talcum reinforcement.

The cell contacting system 200 in the form of the cover 112 is preferably completely pre-assembled as a separate assembly. In the case of a pre-assembly of this sort, the closure element 126 is preferably connected to the carrier element 122 in captive manner

Furthermore, the voltage tapping lines 180 and the temperature measuring lines 182 are connected to the cell connectors 118 and the power terminals 120 and also to the plugs 172 and are fixed to the reinforcement structures 184 of the conduit systems 174, preferably in releasable manner.

Furthermore, if the reinforcement structures 184 are not already connected in any way to the carrier element 122, in one piece manner for example, the reinforcement structures 184 are fixed to the inner surface 160 of the carrier element 122.

Consequently, all of the components needed for contacting the electro-chemical cells 104 of an electro-chemical module 102 are combined in an assembly in the form of an easily handled unit and are already in the requisite relative positions.

The cell connectors 118, the power terminals 120 and/or the reinforcement structures 184 of the conduit systems 174 can, in particular, be fixed to the carrier element 122 by a latching means, by welding and/or by a clipping process.

During the process of assembling an electro-chemical module 102, the carrier element 122 of the cover 112 is placed on the housing 106 in which the electro-chemical cells 104 are arranged and is connected to the edge of the housing 106 surrounding the housing opening 110.

Subsequently, the closure element 126 of the cover 112 is moved into the open position illustrated in FIG. 4, in which the closure element 126 exposes the access openings 130 of the carrier element 122, so that the functional elements 132 of the cell contacting system 200 which are arranged on the inner surface 160 of the carrier element 122, and in particular the cell connectors 118 and the power terminals 120, are accessible from the outer surface 158 of the closure element 126.

Subsequently, the functional elements 132, and in particular the cell connectors 118 and the power terminals 120, are contacted in electrically conductive manner by the respectively associated cell terminals 114 of the electro-chemical module 102, for example by welding, especially by means of a laser, and through the access openings 130 of the carrier element 122 which are exposed in the open position of the closure element 126.

After the process of making contact between the functional elements 132 and the cell terminals 114 of the electro-chemical cells 104 of the electro-chemical module 102 has been effected, the closure element 126 is moved into the closed position illustrated in FIG. 1 in which the closure element 126 closes the access openings 130 of the carrier element 122. In this closed position, the closure element 126 is held on the carrier element 122 by latching means.

Since the carrier element 122 only exposes the contacting regions of the electro-chemical cells 104, and only when the closure element 126 is in the open position, damage to the cell contacting system 200 is prevented when transporting and assembling the electro-chemical module 102.

The small access openings 130 over the contacting regions of the electro-chemical cells 104 reduce the risk that the electrically conductive parts of the cell contacting system 200 will be touched inadvertently and thus substantially decrease the potential danger.

The completely assembled electro-chemical module 102 can be combined with a plurality of other electro-chemical modules 102 to form the electro-chemical device 100, whereby, in particular, different electro-chemical modules 102 can be connected together by means of (not shown) module connectors which interconnect the power terminals 120 of the different electro-chemical modules 102.

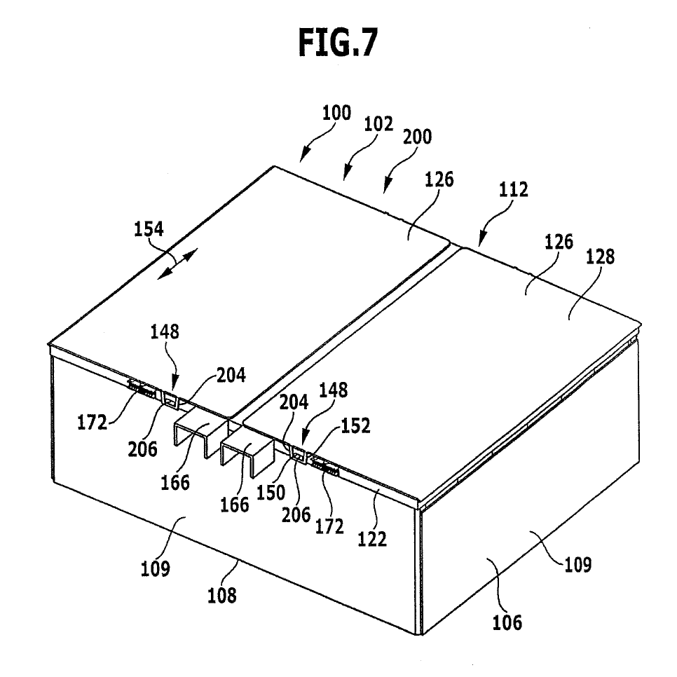

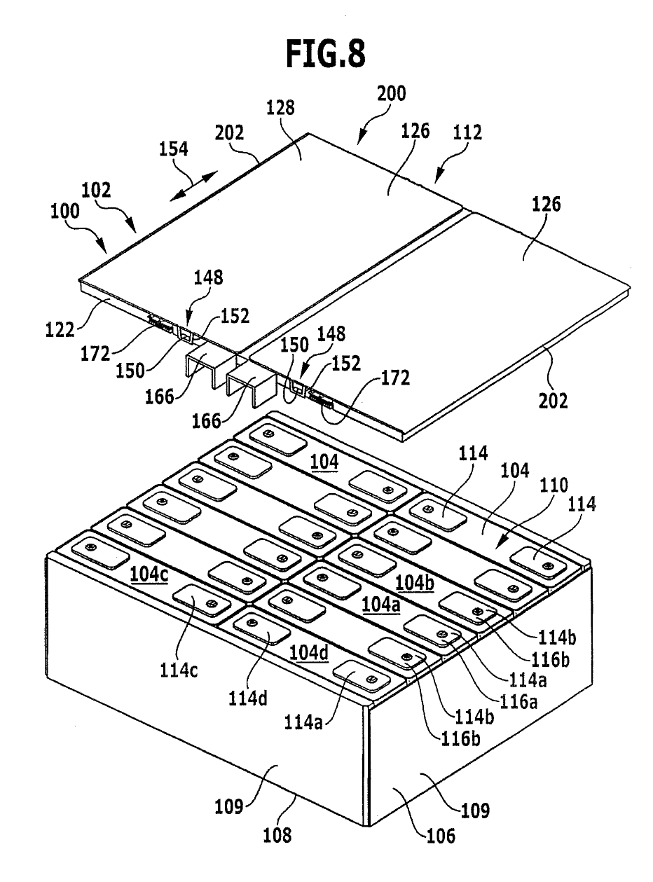

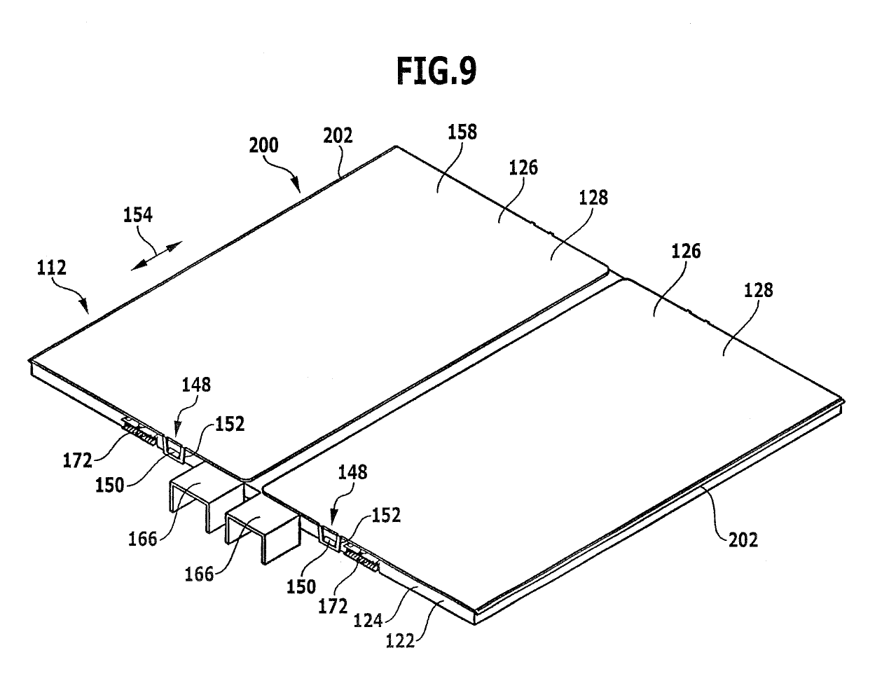

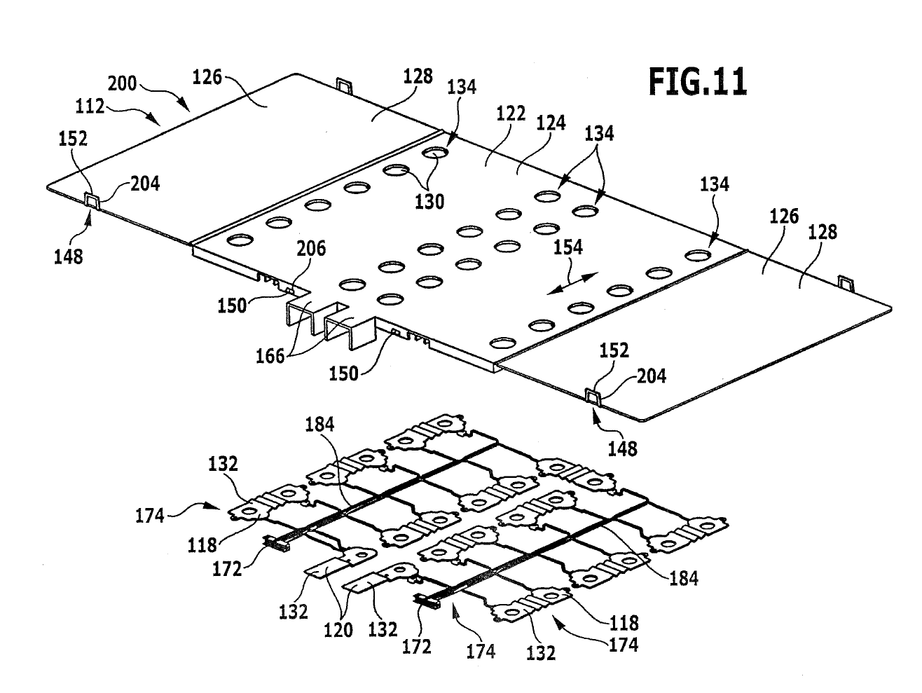

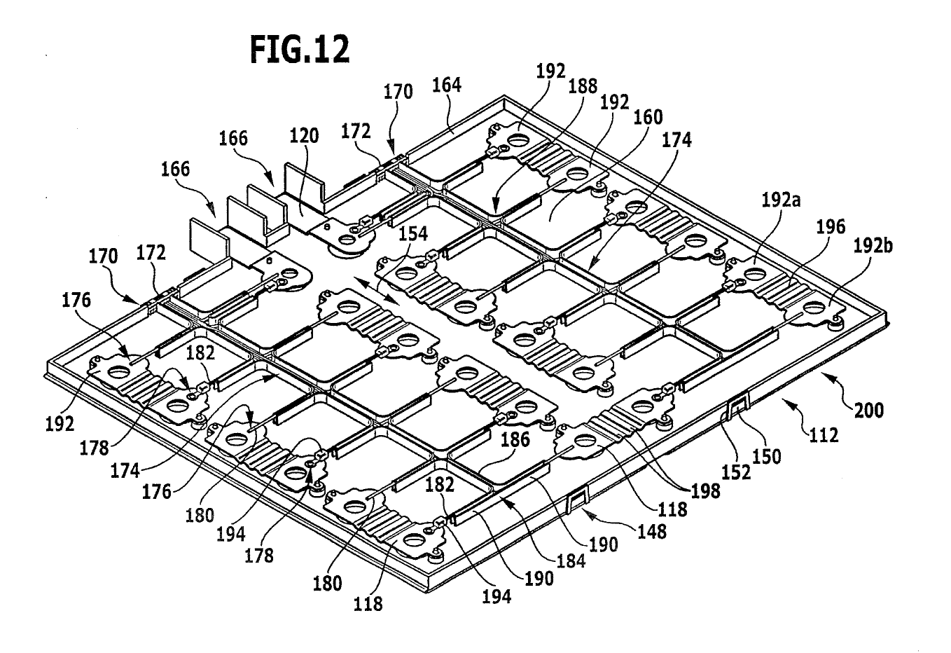

A second embodiment of an electro-chemical device which is shown in FIGS. 7 to 12 differs from the first embodiment shown in FIGS. 1 to 6 only in that the cover 112 is not a closure element 126 that is held on the carrier element 122 in displaceable manner, but instead it comprises two closure elements 126 which are arranged foldably on the carrier element 122.

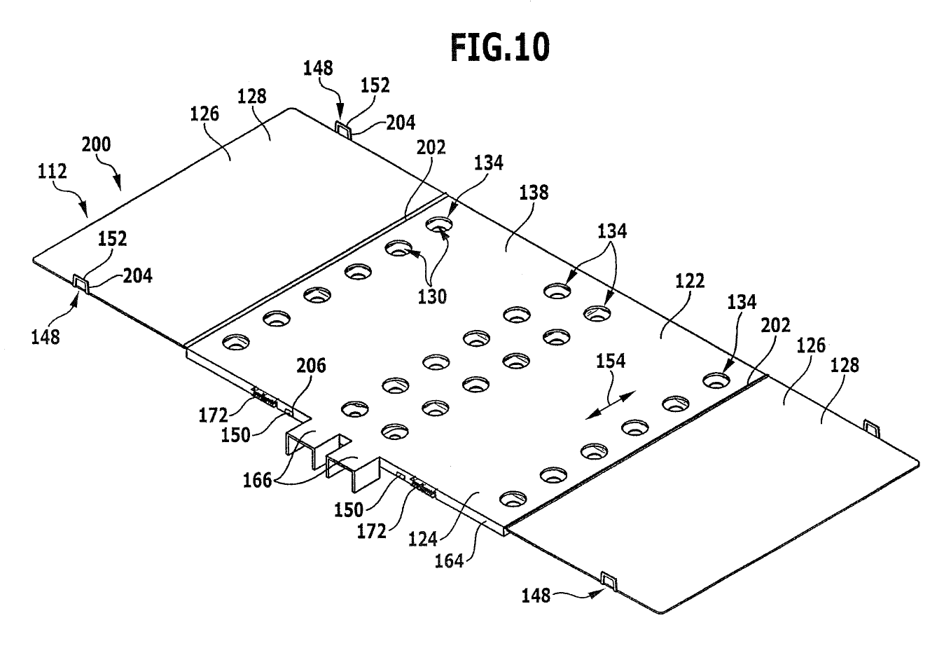

As can best be seen from FIG. 10, the two closure elements 126 are preferably held foldably on mutually opposite edges of the carrier element 122.

In particular, each of the closure elements 126 can be connected to the carrier element 122 foldably by means of a respective film hinge 202.

The two closure elements 126 are preferably formed in one piece manner with the carrier element 122.

In particular, the whole entity consisting of the carrier element 122 and the two closure elements 126 can be made from an injection mouldable synthetic material by means of an injection moulding process.

Each of the closure elements 126 is preferably movable from the closed position illustrated in FIG. 7, in which the respective closure elements 126 close access openings 130 of the carrier element 122, into the open position illustrated in FIG. 10 in which the respective closure element 126 exposes the respectively associated access openings 130 of the carrier element by being folded or pivoted through an angle of more than 90°, preferably through an angle of more than 170°, and in particular through an angle of approximately 180°.

In this embodiment, it is preferable that the closure elements 126 do not have through openings 156 but rather, are preferably of closed construction.

In order to prevent the closure elements 126 from being unintentionally freed from their closed position on the carrier element 122, each of the closure elements 126 is latchable to the carrier element 122 by means of a latching device 148 when it is in the closed position.

The latching device 148 comprises one or more latching elements 152 on the closure element side which are for example in the form of (preferably resiliently deformable) latching hasps 204 and which, in the closed position of the closure element 126, cooperate with a respective latching element 150 on the carrier element side in the form of a latching projection 206 for example in order to latch the respective closure element 126 to the carrier element 122 when it is in the closed position.

The respective closure element 126 can be freed from its closed position on the carrier element 122 and transferred into its open position by overcoming the latching force of the latching device 148.

In all other respects, the second embodiment of an electro-chemical device 100 with a cover 112 which is illustrated in FIGS. 7 to 12 corresponds in regard to the construction, functioning and production thereof to the first embodiment which is illustrated in FIGS. 1 to 6 and to this extent reference is made to the previous description.

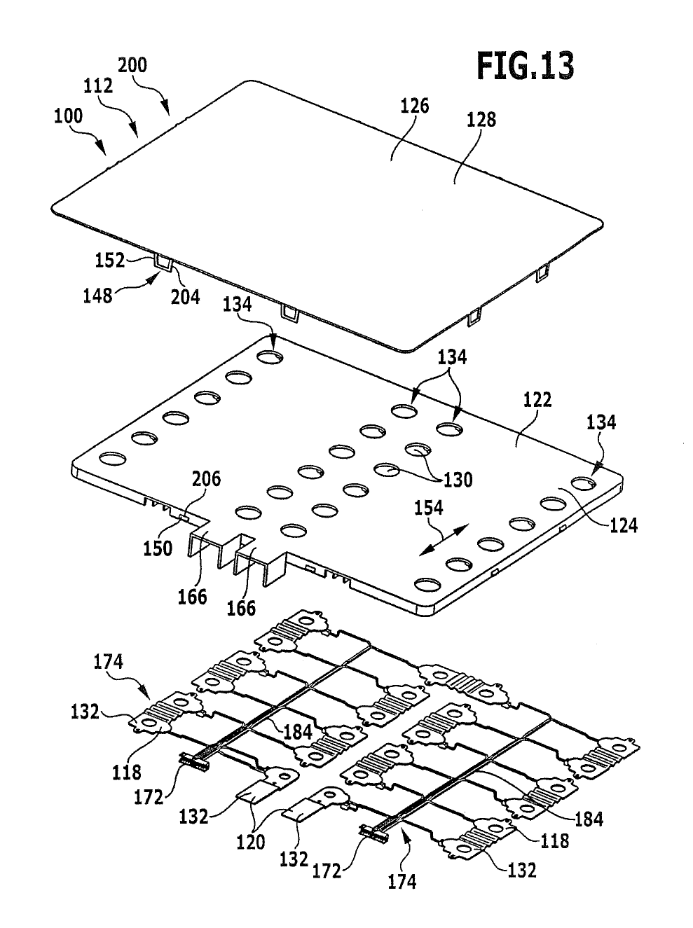

A third embodiment of an electro-chemical device 100 which is illustrated in FIG. 13 differs from the first embodiment shown in FIGS. 1 to 6 only in that the closure element 126 is not held on the carrier element 122 in displaceable manner, but rather it is latched to the carrier element 122 when in its closed position and is movable from the closed position in which the closure element closes the access openings 130 of the carrier element 122, into an open position in which the closure element exposes the access openings 130 of the carrier element, by unlatching the closure element 126 from the carrier element 122 and lifting the closure element 126 off the carrier element 122 in the vertical direction for example.

In this embodiment the closure element 126 preferably has no through openings 156, but is preferably of closed construction.

In order to secure the closure element 126 to the carrier element 122 in its closed position so as to prevent the unintentional removal thereof from the carrier element 122, there is preferably provided a latching device 148 by means of which the closure element 126 is latchable to the carrier element 122 when in its closed position.

The latching device 148 comprises one or more latching elements 152 on the closure element side which are in the form of e.g. latching hasps 204 and which, in the closed position of the closure element 126, cooperate with a respective latching element 150 on the carrier element side in the form of a latching projection 206 for example in order to latch the closure element 126 to the carrier element 122 in the closed position thereof.

The closure element 126 is releasable from its latched position on the carrier element 122 in order to be moved from the closed position into the open position by lifting the closure element 126 off the carrier element 122 by overcoming the latching force of the latching device 148.

In all other respects, the third embodiment of an electro-chemical device 100 with a cover 112 which is illustrated in FIG. 13 corresponds in regard to the construction, functioning and production thereof to the first embodiment which is illustrated in FIGS. 1 to 6 and to this extent reference is made to the previous description.

1. A cover for an electro-chemical device which comprises a plurality of electro-chemical cells, comprising:
a carrier element having at least one access opening which is associated with a functional element of the electro-chemical device; and
at least one closure element which is held on the carrier element in such a manner that the closure element is movable relative to the carrier element from a closed position, in which the closure element closes at least one access opening of the carrier element, into an open position, in which the closure element exposes the at least one access opening of the carrier element, so that the functional element associated with the access opening concerned is accessible from outside the electro-chemical device.

2. The cover in accordance with claim 1, wherein the closure element has at least one through opening which at least partially overlaps an access opening of the carrier element in the open position of the closure element.

3. The cover in accordance with claim 1, wherein the closure element is held captive on the carrier element.

4. The cover in accordance with claim 1, wherein the closure element is formed in one piece manner with the carrier element.

5. The cover in accordance with claim 1, wherein the closure element is pivotal, foldable or rotatable relative to the carrier element.

6. The cover in accordance with claim 1, wherein the closure element is connected by a film hinge to the carrier element.

7. The cover in accordance with claim 1, wherein the closure element is displaceable relative to the carrier element from the closed position into the open position.

8. The cover in accordance with claim 7, wherein the cover comprises a guidance device by means of which the closure element is guided in displaceable manner relative to the carrier element.

9. The cover in accordance with claim 1, wherein the closure element is removable from the carrier element.

10. The cover in accordance with claim 1, wherein the closure element is latchable to the carrier element by means of a latching device in the closed position and/or in the open position.

11. The cover in accordance with claim 1, wherein at least one conduit system is arranged on the carrier element, wherein the conduit system comprises at least one line which is connected to a cell connector for connecting a first cell terminal of a first electro-chemical cell and a second cell terminal of a second electro-chemical cell of the electro-chemical device in an electrically conductive manner

12. The cover in accordance with claim 1, wherein the entire cross-sectional area of the access openings in the carrier element amounts to less than half the surface area covered by the outer contour of the carrier element.

13. The cover in accordance with claim 1, wherein the closure element is arranged on an outer surface of the carrier element that is remote from the electro-chemical cells of the electro-chemical device.

14. The cover in accordance with claim 1, wherein at least one functional element of the electro-chemical device is mounted on the carrier element.

15. The cover in accordance with claim 14, wherein at least one cell connector for the electrically conductive connection of a first cell terminal of a first electro-chemical cell and a second cell terminal of a second electro-chemical cell of the electro-chemical device is mounted on the carrier element.

16. The cover in accordance with claim 15, wherein a contact region of the at least one cell connector, at which the cell connector is connectable to the first cell terminal or to the second cell terminal, is accessible through an access opening of the carrier element in the open position of the closure element.

17. The cover in accordance with claim 1, wherein the carrier element and/or the closure element are formed from an electrically non-conductive material.

18. An electro-chemical device comprising a plurality of electro-chemical cells and a cover for the electro-chemical device, said cover comprising:
a carrier element having at least one access opening which is associated with a functional element of the electro-chemical device; and
at least one closure element which is held on the carrier element in such a manner that the closure element is movable relative to the carrier element from a closed position, in which the closure element closes at least one access opening of the carrier element, into an open position, in which the closure element exposes the at least one access opening of the carrier element, so that the functional element associated with the access opening concerned is accessible from outside the electro-chemical device.

19. A method for contacting electro-chemical cells of an electro-chemical device comprising the following process steps:
mounting at least one cell connector for the electrically conductive connection of a first cell terminal of a first electro-chemical cell and a second cell terminal of a second electro-chemical cell on a carrier element of a cover;
arranging the cover on the electro-chemical device;
connecting a first contact region of the at least one cell connector to the first cell terminal of the first electro-chemical cell and a second contact region of the cell connector to the second cell terminal of the second electro-chemical cell whilst a closure element of the cover is in an open position in which the closure element exposes at least one access opening of the carrier element so that the contact regions of the cell connector are accessible from outside the electro-chemical device; and
moving the closure element from the open position into a closed position in which the closure element closes the at least one access opening of the carrier element.
